(19) United States
(12) Patent Application Publication
(10) Pub. No.: US 2003/0114129 A1
(43) Pub. Date: Jun. 19, 2003

(54) System and method for a radio frequency receiver front end utilizing a balun to couple a low-noise amplifier to a mixer

(76) Inventor: Albert C. Jerng, Sunnyvale, CA (US)

Correspondence Address: MORRISON & FOERSTER LLP, 425 MARKET STREET, SAN FRANCISCO, CA, 94105-2482, US

(21) Appl. No.: 10/023,580

(22) Filed: Dec. 17, 2001

(51) Int. Cl. H04B 1/26

(52) U.S. Cl. 455/323; 455/326; 455/333

(57) ABSTRACT

An embodiment of this invention pertains to a fully integrated, highly linear, and power-efficient balun circuit and voltage-to-current converter that interfaces a single-ended low noise amplifier (“LNA”) and a differential mixer. The balun circuit includes components that perform the following functions: provide a load element for the LNA, resonate at the desired frequency of operation to maximize a gain of a single-ended signal output from the single-ended LNA, stabilize the gain of the single-ended signal; convert the single-ended signal to a differential signal, match the impedance between the single-ended LNA and the differential mixer to maximize the power transfer of the differential signal, improve the balance of the differential signal, provide a bias to the LNA, provide a bias for a voltage-to-current converter portion of the differential mixer, and differentially drive a pair of grounded source transistors that linearly convert the differential signal in voltage form to current form. The voltage to current conversion occurs without using a current source in the voltage-to-current converter portion of the differential mixer.

### BACKGROUND OF THE INVENTION

1. Field of the Invention

This invention relates generally to a radio frequency receiver front end, and more particularly, to using an integrated balun to interface a low noise amplifier to a mixer.

2. Description of the Related Art

The current trend in radio frequency integrated circuit design is to completely integrate all components of a radio onto a single piece of silicon die. This trend is driven by the market demand for low cost, small form factor, and low power integrated circuits for wireless applications such as cordless phones, cellular, and data networking.

As described in papers, product application notes, and textbooks, there are currently several approaches to the design of a radio frequency (“RF”) receiver front end. FIG. 1 shows a prior art RF receiver front end 20. It includes an antenna 40 that, among other functions, converts an incoming electromagnetic field to a single-ended RF input signal. The RF receiver front end 20 also includes a low-noise amplifier (“LNA”) 23 followed by the mixer 26. The LNA 23 receives the weak RF input signal from the antenna 40 and amplifies the signal while adding as little noise as possible. The mixer 26 then converts its input signal from its RF frequency to a lower intermediate frequency for further processing by the receiver. The mixer 26 produces the intermediate frequency signal by subtracting the RF input at the RF frequency from a signal produced by a local oscillator 52. When designing the RF receiver front end 20, the relevant factors include noise figure, linearity, gain, and power consumption.

The LNA 23 typically processes single-ended (i.e., unbalanced) signals while the mixer 26 processes differential (i.e., balanced) signals. The LNA 23 is usually single-ended so that it can interface with the single-ended antenna 40. If the LNA 23 is made to be differential for easier interface to the subsequent mixer, then an external balun is used after the antenna to interface to the LNA. The balun (short for BALanced to UNbalanced) is a transformer that converts (i.e., transforms) a single-ended signal to a differential signal. The single-ended signal line (i.e., the unbalanced signal line) has just one conductor; the current in it returns via a common ground or earth path. The differential signal line (i.e., the balanced signal line) has two signal line conductors, with equal currents in opposite directions. This external balun is bulky, costly, and not integrated within the integrated RF receiver front end. Thus the use of the balun is contradictory to the market demands for low cost, small form factor, and low power consumption. Also, the differential LNA requires twice the power consumption as the single-ended LNA to achieve the same noise figure. Meanwhile, the downconversion mixer is typically designed as a differential (i.e., balanced) circuit because differential circuits cancel out unwanted products created by the frequency mixing process. This balanced operation of the mixer also improves linearity, removes noise sources, and creates less interference to the other circuitry that must be integrated on the same die.

If the LNA 23 is single-ended and the mixer 26 is differential, then an interface circuit 29 is used within the RF receiver front end 20 to interface the single-ended LNA to the differential mixer. The interface circuit 29 is circuitry that converts the single-ended signal to the differential signal. The interface circuit 29 between the single-ended LNA and the differential mixer is an important component of the RF receiver front end 20. In the past, this interface was typically done with high quality external components not integrated on silicon. Today, with the current market trends, as stated earlier, there is a need to integrate this interface without compromising on the specifications of noise figure, linearity, and power consumption.

FIG. 2 shows a prior art RF receiver front end 100 in which the interface circuit is an active single-ended to differential converter. Various devices can be used to implement the active single-ended to differential converter. In FIG. 2, the active single-ended to differential converter is implemented using a differential pair gain stage 104.

The single-ended LNA 102 includes a voltage supply 118, a resistor 120, a capacitor 122, an inductor 108, a voltage supply 110, a transistor 112, a transistor 114, an inductor 116, and a RF input node 170. The transistor 112 and the transistor 114 perform voltage-to-current conversion of the single-ended RF input signal received at the RF input node 170. The resistor 120, the capacitor 122, and the inductor 108 act as the load of the transistors 112 and 114 and this load converts the current back to voltage. The voltage-to-current converter and the load together combine to amplify the single-ended RF input signal.

The lower portion of the differential mixer 106 includes a transistor 150, a transistor 152, a resistor 156, a resistor 154, and a voltage supply 158. This lower portion converts voltage received from the differential pair gain stage 104 to current. The upper portion of the differential mixer 106 includes a transistor 160, a transistor 162, a transistor 164, a transistor 166, an output node 172a, and an output node 172b. A local oscillator 180 produces a signal and this signal is mixed by the upper portion of the differential mixer 106 with the differential signal provided by the drain of transistor 150 and the drain of transistor 152 to produce an intermediate frequency output that is at a lower frequency than the differential signal input into the upper portion. The intermediate frequency differential signal is sent to other parts of the receiver using the two output nodes 172a and 172b.

The differential pair gain stage 104 includes a resistor 140, a resistor 142, a transistor 122, a transistor 124, a resistor 126, a voltage supply 128, a current source 130, a resistor 132, a capacitor 134, a capacitor 136, and a capacitor 138. The differential pair gain stage 104 interfaces the single-ended LNA 102 and the differential mixer 106 by converting the single-ended signal received from the single-ended LNA 102 to a differential signal that is transmitted to the differential mixer 106. The transistor 122 and the transistor 124 perform the conversion from the single-ended signal to the differential signal.

The RF receiver front end 100 shown in FIG. 2 does not use any external components, i.e., the front end is fully integrated. However, the differential pair gain stage 104 is an active device meaning that it uses a power supply (i.e., the current source 130) for its operation. The active differential pair gain stage 104 introduces additional noise to the receiver, degrades system linearity, and consumes additional power. These are all serious drawbacks for a high dynamic range RF receiver front end.

FIG. 3 shows a prior art RF receiver front end 200 in which the function of the interface circuit is performed within a differential mixer 204. The RF receiver front end 200 includes a single-ended LNA 202 and a differential mixer 204. The single-ended LNA 202 includes a voltage supply 206, a resistor 208, a capacitor 210, an inductor 212, a voltage supply 214, a transistor 216, a transistor 218, an inductor 220, a RF input node 224, and a capacitor 222. The transistor 216 and the transistor 218 perform voltage-to-current conversion of the single-ended RF input signal received at the RF input node 224. The resistor 208, the capacitor 210, and the inductor 212 act as the load of the transistors 216 and 218 and this load converts the current back to voltage. The voltage-to-current converter and the load together combine to amplify the single-ended RF input signal.

The differential mixer 204 includes a lower portion and an upper portion. The lower portion includes a resistor 250, a transistor 252, a transistor 254, a resistor 258, a capacitor 260, a voltage supply 262, and a current source 256. This lower portion performs the single-ended to differential conversion and also performs the voltage to current conversion. The upper portion of the differential mixer 204 includes a transistor 266, a transistor 268, a transistor 270, a transistor 272, an output node 276a, an output node 276b, a resistor 278, and a resistor 280. The upper portion mixes the differential input provided by the drain of the transistor 252 and the drain of the transistor 254 with the signal generated from a local oscillator 264 to produce an intermediate frequency differential signal that is at a lower frequency than the differential input. The output node 276a and the output node 276b allow the RF receiver front end 200 to transmit the intermediate frequency differential signal to other parts of the receiver.

While the use of the voltage to current converter in the differential mixer 204 as an active single-ended to differential converter eliminates the intermediate converter stage, it also places difficult constraints on the differential mixer's 204 design requiring special consideration (especially in complementary metal-oxide semiconductor (“CMOS”) technology) for achieving balanced signals in the differential pair. It also requires the current source 256 at the bottom of the differential pair which makes low voltage and hence, low power consumption design more difficult.

FIG. 4 shows a prior art RF receiver front end 300 that uses both a differential LNA 302 and a differential mixer 304. The differential LNA 302 includes a voltage supply 308, a resistor 310, a capacitor 312, an inductor 314, an inductor 316, a capacitor 318, a resistor 320, a capacitor 315, a capacitor 317, a voltage supply 322, a transistor 324, a transistor 338, a voltage supply 336, a transistor 328, a transistor 334, a RF input node 326a, a RF input node 326b, an inductor 330, and an inductor 332. A first half of the differential signal is input into the differential LNA 302 using the RF input node 326a and a second half of the differential signal is input using the RF input node 326b. The transistor 328 and the transistor 324 perform voltage-to-current conversion of the first half of the differential signal. The resistor 310, the capacitor 312, and the inductor 314 act as the load of the transistors 324 and 328 and this load converts the current back to voltage. The voltage-to-current converter and the load together combine to amplify the first half of the differential signal. The transistor 334 and the transistor 338 perform voltage-to-current conversion of the second half of the differential signal. The resistor 320, the capacitor 318, and the inductor 316 act as the load of the transistors 334 and 338 and this load converts the current back to voltage. This voltage-to-current converter and this load together combine to amplify the second half of the differential signal.

The differential mixer 304 includes a lower portion and an upper portion. The lower portion includes a resistor 368, a transistor 360, a transistor 362, a resistor 366, and a voltage supply 364. The upper portion includes a transistor 370, a transistor 372, a transistor 374, a transistor 376, an output node 380a, an output node 380b, a resistor 384, and a resistor 382. The lower portion amplifies the differential signal received by the gate of the transistor 360 and the gate of the transistor 362 before it is downconverted by the upper portion. The upper portion mixes the differential input provided by the drain of the transistor 360 and the drain of the transistor 362 with the signal generated from a local oscillator 350 to produce an intermediate frequency differential signal that is at a lower frequency than the differential input. The output node 380a and the output node 380b allow the RF receiver front end 300 to transmit the intermediate frequency differential signal to other parts of the receiver.

In the design shown in FIG. 4, the differential interface is implemented on-chip using the on-chip inductor 330 and the inductor 332 as a matching network that match the impedance of an external balun used to interface the single-ended antenna to the differential inputs of the differential LNA 302. Since the input to the differential LNA 302 is a differential signal, the differential LNA 302 has to have the external balun to interface to the antenna. For the reasons provided earlier, the use of an external balun is undesirable. Also, the additional transistors (i.e., the transistor 334 and the transistor 338) in the differential LNA 302 doubles the power consumption compared to a single-ended LNA and degrades the noise figure (i.e., the additional transistors contribute additional noise).

FIG. 5 shows a prior art RF receiver front end 400 that uses both a single-ended LNA 402 and a single-ended mixer 404. The single-ended LNA 402 includes a voltage supply 408, a resistor 410, a capacitor 412, an inductor 414, a capacitor 426, a voltage supply 416, a transistor 420, a transistor 422, an inductor 424, and a RF input node 418. The transistor 420 and the transistor 422 perform voltage-to-current conversion of the single-ended RF input signal received at the RF input node 418. The resistor 410, the capacitor 412, and the inductor 414 act as the load of the transistors 422 and 420 and this load converts the current back to voltage. The voltage-to-current converter and the load together combine to amplify the single-ended RF input signal.

The single-ended mixer 404 includes a lower portion and an upper portion. The lower portion includes a transistor 454, a resistor 452, and a voltage supply 450. The upper portion includes a transistor 456, a transistor 453, an output node 460a, an output node 460b, a resistor 462, and a resistor 464. The lower portion performs the voltage-to-current conversion and amplifies the single-ended signal received at the gate of the transistor 454. The upper portion mixes the single-ended signal produced by the drain of the transistor 454 with the signal generated from a local oscillator 470 to produce an intermediate frequency differential signal that is at a lower frequency than the single-ended signal produced by the drain of the transistor 454. The output node 460a and the output node 460b allow the RF receiver front end 400 to transmit the intermediate frequency differential signal to other parts of the receiver.

In the design shown in FIG. 5, the single-ended interface is implemented on-chip using the on-chip inductor 424 to match the impedance of the antenna. The drawback of this design is that the single-ended mixer 404 will generate even-order nonlinearities and unwanted mixing products including feed through of the local oscillator mixing signal. The single-ended mixer 404 will suffer degraded linearity and be less desirable for fully integrated RF receiver designs.

For the foregoing reasons, it is desirable to have a fully integrated RF receiver front end in which the interface between the single-ended LNA and the differential mixer is on-chip and this interface does not compromise the relevant factors of a RF receiver such as noise figure, linearity, gain, and power consumption.

### SUMMARY OF THE INVENTION

According to an embodiment of the present invention, an integrated radio frequency (“RF”) receiver front end is described. The front end includes a balun circuit that includes a first inductor and a second inductor that is magnetically coupled to the first inductor. The two inductors together transform a single-ended signal to a differential signal. The second inductor has a center tap node. The balun circuit also includes a first capacitor that is coupled in parallel to the first inductor and that forms a resonance with the first inductor to maximize a gain of the single-ended signal. The balun circuit further includes a first resistor, coupled in parallel to the first capacitor, that stabilizes the gain of the single-ended signal. Also included are a second capacitor, coupled at one end to the center tap node and to AC ground at the other end, to improve the balance between a first half of the differential signal and a second half of the differential signal; a third capacitor, coupled in parallel to the second inductor; and a fourth capacitor, coupled in parallel to the third capacitor, that together with the third capacitor matches the impedance between a low noise amplifier and a mixer. The front end also includes the mixer and this mixer is coupled to the balun circuit. The mixer includes a first transistor having a source, a gate, and a drain where the gate is coupled to the fourth capacitor, the source is coupled to ground, and the drain produces a first half of a differential signal in current form. The mixer further includes a second transistor that together with the first transistor converts the differential signal from a voltage form to a current form. The second transistor also has a source, a gate, and a drain, where the gate is coupled to the fourth capacitor, the source is coupled to ground, and the drain produces a second half of the differential signal in current form.

According to an embodiment of the present invention, an integrated balun circuit that receives a single-ended signal is described. This circuit includes: a balun to passively convert a single-ended signal to a differential signal; a resonance forming unit, coupled to the balun, to maximize a gain of the single-ended signal; a gain stabilizing unit, coupled to the balun, to stabilize the gain of the single-ended signal; a balun grounding unit, coupled to the balun, to improve the balance between a first half of the differential signal and a second half of the differential signal; and an impedance matching unit, coupled to the balun, to match the impedance between a low noise amplifier and a mixer in order to maximize transfer of the passively converted differential signal.

According to an embodiment of the present invention, a RF receiver front end is described. The front end includes: a balun to passively convert a single-ended signal to a differential signal; a resonance forming unit, coupled to the balun, to maximize a gain of the single-ended signal; a gain stabilizing unit, coupled to the balun, to stabilize the gain of the single-ended signal; a balun grounding unit, coupled to the balun, to improve the balance between a first half of the differential signal and a second half of the differential signal; an impedance matching unit, coupled to the balun, to match the impedance between a low noise amplifier and a mixer in order to maximize transfer of the passively converted differential signal; and a voltage-to-current converter to convert the differential signal from a voltage form to a current form without using a current source.

According to an embodiment of the present invention, a method is described to convert a single-ended signal to a differential signal. This method includes: resonating at an operating frequency to maximize a gain of the single-ended signal; stabilizing the gain of the single-ended signal; passively converting the single-ended signal to produce a differential signal; grounding a balun to improve the balance between a first half of the differential signal and a second half of the differential signal; matching the impedance between a low noise amplifier and a mixer to maximize the power transfer of the differential signal; and converting the differential signal from a voltage form to a current form without using a current source.

### BRIEF DESCRIPTION OF THE DRAWINGS

FIG. 1 shows a prior art radio frequency (“RF”) receiver front end.

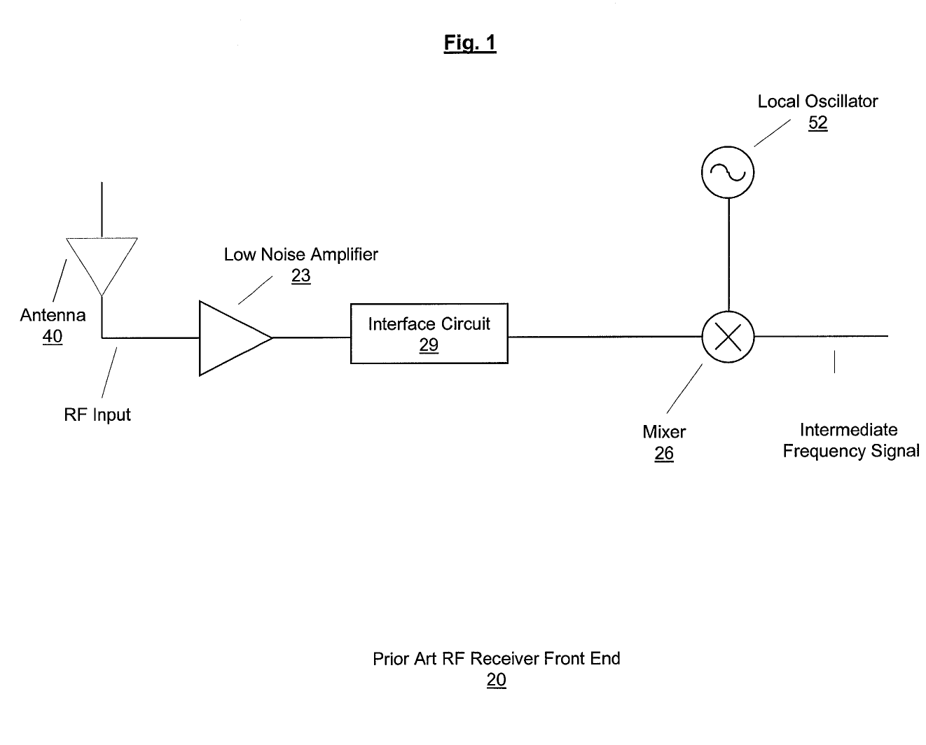

FIG. 2 shows a prior art RF receiver front end in which the interface circuit is an active single-ended to differential converter.

FIG. 3 shows a prior art RF receiver front end in which the function of the interface circuit is performed within a differential mixer.

FIG. 4 shows a prior art RF receiver front end that uses both a differential LNA and a differential mixer.

FIG. 5 shows a prior art RF receiver front end that uses both a single-ended LNA and a single-ended mixer.

FIG. 6 shows a block diagram of an embodiment of an integrated RF receiver front end according to the present invention.

FIG. 7 shows a functional block diagram of the embodiment of the integrated RF receiver front end according to the present invention.

FIG. 8 shows a flowchart of an embodiment of a method to convert a single-ended signal to a differential signal according to the present invention.

FIG. 9 shows a circuit diagram of the embodiment of the integrated RF receiver front end according to the present invention.

### DETAILED DESCRIPTION OF THE INVENTION

An embodiment of this invention is a fully integrated, highly linear, low noise, high gain and power-efficient system and method for interfacing a single-ended LNA to a differential mixer. This embodiment includes a balun circuit and a voltage to current converter portion of a differential mixer that together provide the fully integrated, highly linear, low noise, high gain and power-efficient interface. The balun circuit includes components that perform the following functions: provide a load element for the LNA, resonate at the desired frequency of operation to maximize a gain of a single-ended signal output from the single-ended LNA, stabilize the gain of the single-ended signal; passively convert the single-ended signal to a differential signal, match the impedance between the single-ended LNA and the differential mixer to maximize the power transfer of the differential signal, improve the balance of the differential signal, provide a bias for a voltage-to-current converter portion of the differential mixer, and differentially drive a pair of grounded source transistors that linearly convert the differential signal in voltage form to current form. The voltage to current converter portion of the differential mixer does not use a current source and thus provides low voltage, low power, and highly linear operation. In addition, the grounded-source transistors are used within the converter portion because they provide high linearity.

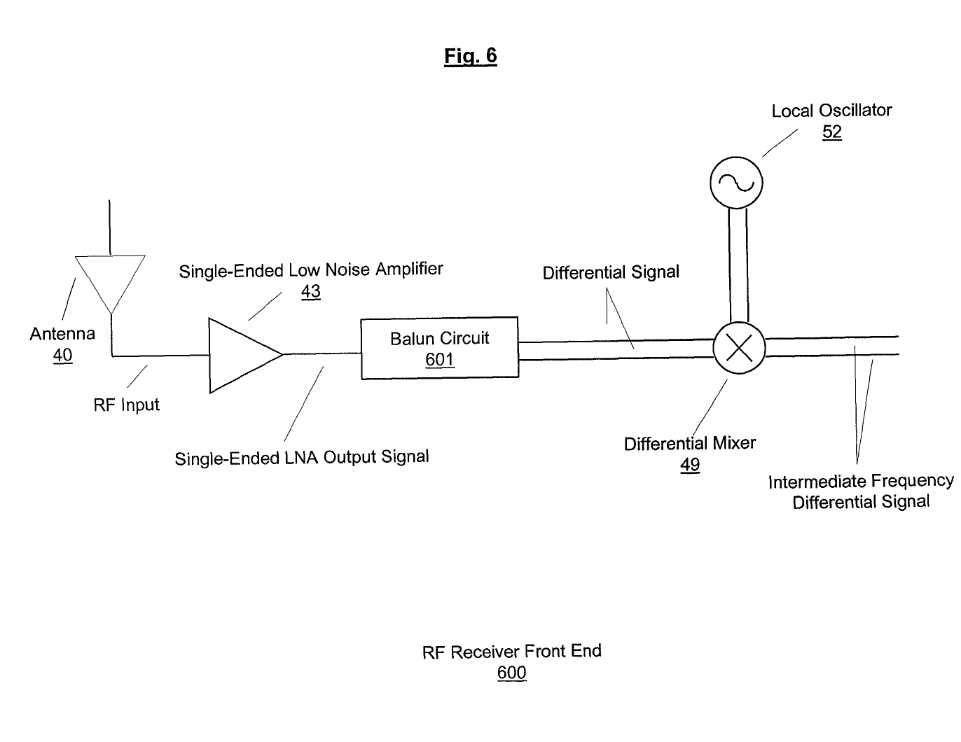

FIG. 6 shows a block diagram of an embodiment of an integrated RF receiver front end 600 according to the present invention. In FIG. 6, a single-ended LNA 43 has as its input the RF input signal and the single-ended LNA 43 produces the single-ended LNA output signal having a voltage gain. A balun circuit 601 converts the single-ended LNA output signal to a differential signal. The differential signal is input into a differential mixer 49. The differential mixer 49 produces the intermediate frequency differential signal which is at a lower frequency than the differential signal by mixing the differential signal with the signal produced by the local oscillator 52.

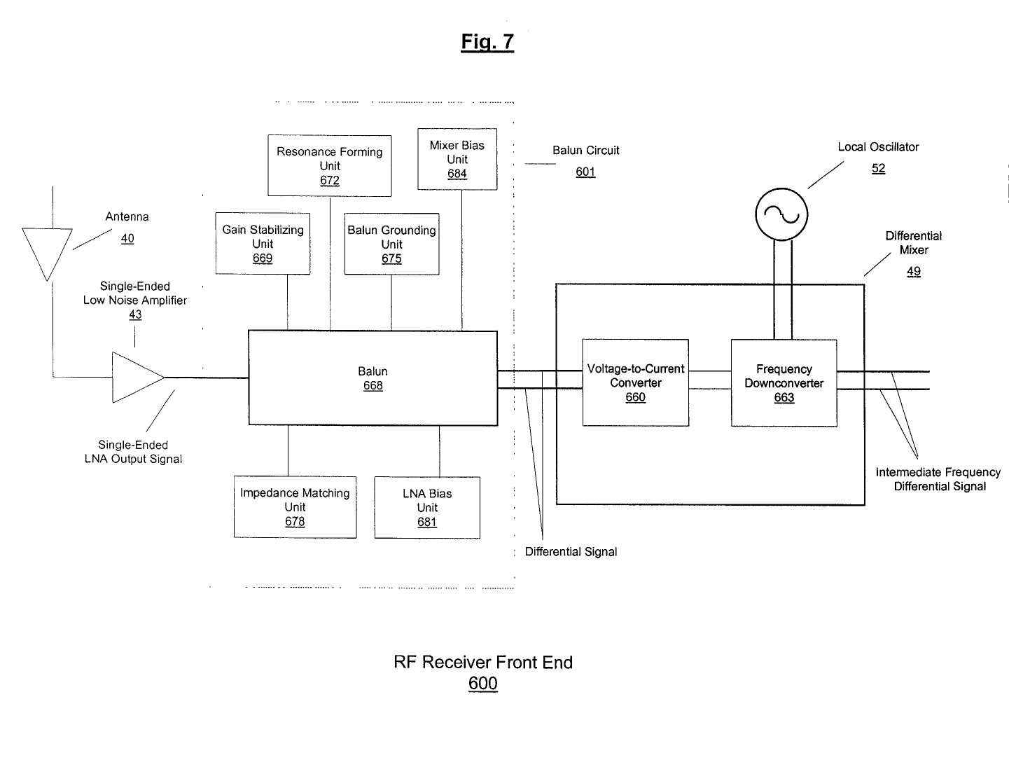

FIG. 7 shows a functional block diagram of the embodiment of the integrated RF receiver front end 600 according to the present invention. In FIG. 7, the single-ended LNA 43 has as its input the RF input signal and it produces the single-ended LNA output signal having a voltage gain. The single-ended LNA output signal is input into a balun 668 of a balun circuit 601. The balun circuit 601 acts as a load element for the single-ended LNA 43 producing a voltage gain at the single-ended LNA's 43 output. The balun circuit 601 is the interface between the single-ended LNA 43 and the differential mixer 49. The balun circuit 601 converts the single-ended LNA output signal to the balanced differential signal. The balun circuit 601 includes the balun 668, a gain stabilizing unit 669, a resonance forming unit 672, a balun grounding unit 675, a mixer bias unit 684, an impedance matching unit 678, and a LNA bias unit 681. The balun 668 linearly converts the single-ended LNA output signal to a differential signal. The resonance forming unit 672 forms a resonance with the balun 668 so that the single-ended LNA output signal has maximum gain. The gain stabilizing unit 669 stabilizes the gain of the single-ended LNA output signal. The balun grounding unit 675 AC grounds the balun 668 to improve the balance and symmetry between the first half of the differential signal and the second half of the differential signal produced at the output of the balun 668. The impedance matching unit 678 matches the impedance between the single-ended LNA 43 and the differential mixer 49 to maximize the gain of the differential signal produced by the balun 668. The mixer bias unit 684 is used to bias the differential mixer 49. The LNA bias unit 681 is used to bias the single-ended LNA 43.

The differential mixer 49 includes a voltage-to-current converter 660 and a frequency downconverter 663. The voltage-to-current converter 660 converts the differential signal produced by the balun 668 from voltage form to current form. The voltage-to-current converter 660 also provides additional gain to the differential signal. The frequency downconverter 663 mixes the differential signal produced by the voltage-to-current converter 660 with a signal produced by a local oscillator 52 to produce an intermediate frequency differential signal that is at a lower frequency than the differential signal produced by the voltage-to-current converter 660.

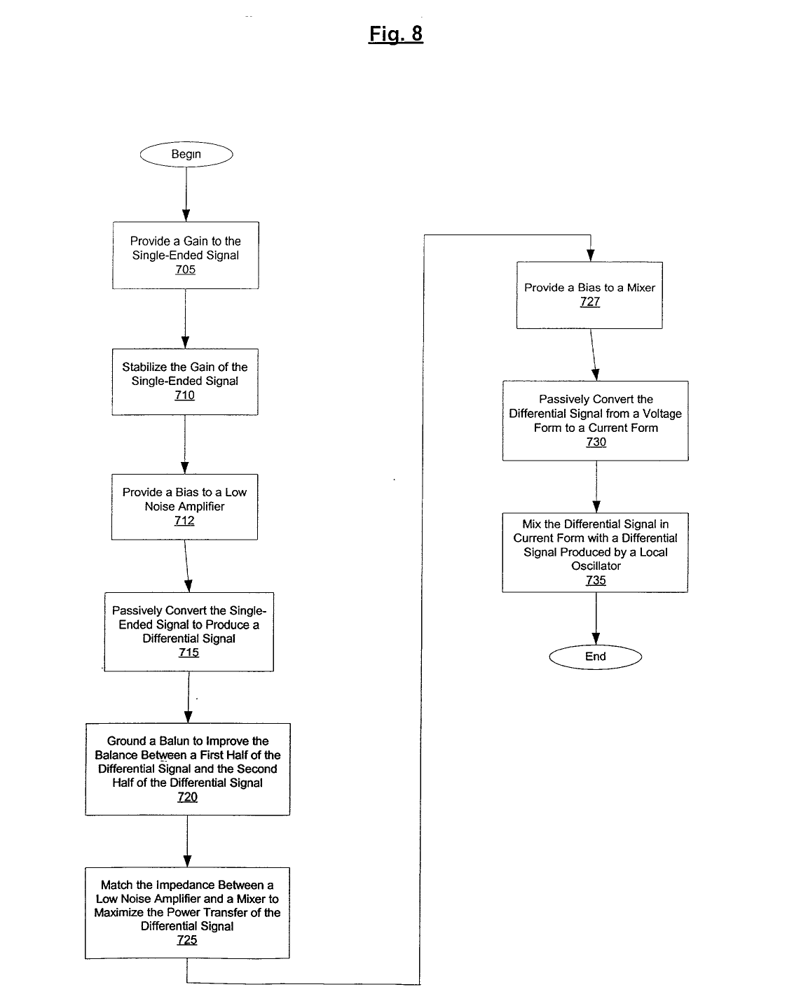

FIG. 8 shows a flowchart of an embodiment of a method to convert the single-ended signal to the differential signal according to the present invention. The single-ended LNA 43 receives the single-ended signal from the antenna 40. In block 705, the single-ended LNA 43 provides a gain (e.g., a voltage gain) to the single-ended signal. In block 710, the gain stabilizing unit 669 stabilizes the gain of the single-ended signal. In block 712, the LNA bias unit 681 provides a bias to the single-ended LNA 43. In block 715, the balun 668 passively converts the amplified single-ended signal across its input to produce the differential signal across its output. When producing the differential signal, the balun 668 filters out low frequency intermodulation products from the single-ended signal. In block 720, the balun 668 is grounded to improve the balance between a first half of the produced differential signal and a second half of the produced differential signal. In block 725, the impedance between the single-ended LNA 43 and the differential mixer 49 is matched to maximize the power transfer of the differential signal from the balun 668 to the input of the voltage-to-current converter 660. In block 727, the mixer bias unit 684 provides a bias to the differential mixer 49. In block 730, the voltage-to-current converter 660 converts the differential signal from a voltage form to a current form. The voltage-to-current converter 660 also provides gain to the differential signal in current form. In block 735, the frequency downconverter 663 mixes the differential signal in current form with a differential signal produced by the local oscillator 52 to produce the intermediate frequency differential signal.

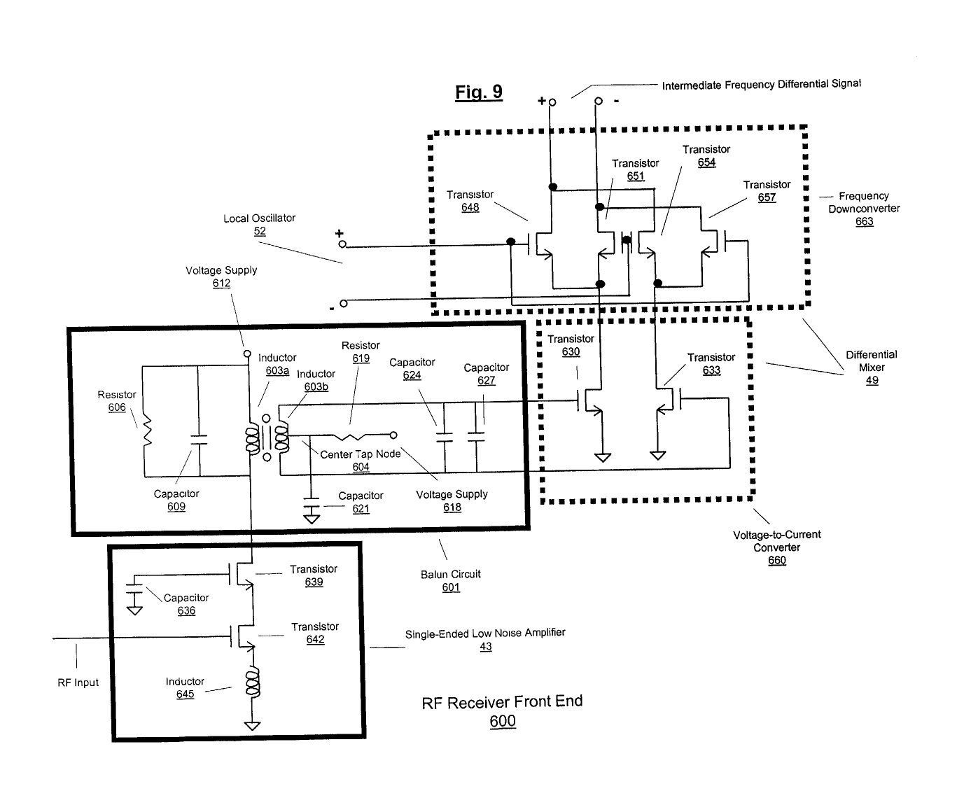

FIG. 9 shows a circuit diagram of an embodiment of the integrated RF receiver front end 600 according to the present invention. The RF receiver front end 600 includes the single-ended LNA 43, the balun circuit 601, and the differential mixer 49. The single-ended LNA 43 includes an inductor 645, a capacitor 636, and a cascode connection of a transistor 642 and a transistor 639. In one configuration of this embodiment, the transistors are field effect transistors. In this configuration, each of the transistors has a gate, a drain, and a source. In other configurations, the transistors can be, for example, bipolar transistors. The transistor 639 and the transistor 642 are used to amplify the RF input received at the gate of the transistor 642. The inductor 645 is coupled to the source of the transistor 642. The inductor 645 matches the impedance of the single-ended LNA 43 to that of the antenna 40. The capacitor 636 is coupled to the gate of the transistor 639. The capacitor 636 couples the gate of the transistor 639 to ground so that the transistor 639 can achieve high current gain from its source to its drain.

The balun circuit 601 includes an inductor 603a, an inductor 603b, a resistor 606, a capacitor 609, a voltage supply 612, a capacitor 621, a resistor 619, a voltage supply 618, a capacitor 624, and a capacitor 627. In this embodiment, the balun 668 is comprised of the inductor 603a and the inductor 603b and these two are interwoven and thus magnetically coupled to each other. The balun 668 simultaneously performs the following functions: (1) provides a load element for the single-ended LNA 43; (2) provides an on-chip matching network between the single-ended LNA 43 and the differential mixer 49 so that maximum power is transferred from the output of the single-ended LNA 43 to the input of the differential mixer 49; (3) provides a bias to the differential mixer 49 (i.e., bias the transistors performing the voltage-to-current conversion in the mixer) through a balun center tap node 604; and (4) provides a linear single-ended to differential converter that consumes zero power (i.e., no current source is needed in the balun circuit 601). The center tap node 604 is attached to the inductor 603b. The center tap node 604 is a connection made to the centermost turn of the inductor 603b.

The capacitor 609 is coupled in parallel to the inductor 603a. The resistor 606 is coupled in parallel to the capacitor 609. The load of the transistors 642 and 639 is the inductor 603a, the capacitor 609, and the resistor 606. This load converts the current produced by the transistors 642 and 639 to a voltage gain at the inductor 603a.

The capacitor 609 is a tuning element that resonates with the inductor 603a at the desired frequency of operation. By resonating with the inductor 603a, the capacitor 609 maximizes the voltage gain produced at the inductor 603a at the desired frequency of operation. In this embodiment, the resonance forming unit 672 shown in FIG. 7 includes the capacitor 609 that is coupled in parallel to the inductor 603a.

The resistor 606 coupled in parallel to the capacitor 609 stabilizes the voltage gain at the inductor 603a over temperature and process variations. In this embodiment, the gain stabilizing unit 669 shown in FIG. 7 includes the resistor 606 that is coupled in parallel to the capacitor 609.

The inductor 603a and the inductor 603b are built intertwined and thus magnetically coupled to each other. The inductor 603a is the primary winding of the balun 668 and the inductor 603b is its secondary winding. The single-ended LNA output signal (i.e., the voltage gain produced by the transistor 642 and the transistor 639) across the inductor 603a is converted to a differential signal across the inductor 603b. This single-ended to differential conversion is done passively and thus is highly linear and does not use an additional power source.

The voltage supply 612 is coupled to the inductor 603a and provides a bias for the LNA 43 (i.e., the voltage supply 612 sets the initial operating point of the transistor 639 and the transistor 642). In this embodiment, the LNA bias unit 681 shown in FIG. 7 includes the voltage supply 612 that is coupled to the inductor 603a.

The capacitor 621 is coupled to the center tap node 604 at one end and is AC coupled to ground at the other end. The capacitor 621 provides an AC bypass ground at the center tap node 604 that improves the balance and symmetry between the first half of the differential signal and the second half of the differential signal produced across the inductor 603b. The balun grounding unit 675 shown in FIG. 7 includes the capacitor 621 coupled to the center tap node 604 and AC coupled to the ground.

The resistor 619 is coupled to the center tap node 604 and the voltage supply 618. The resistor 619 coupled to the center tap node 604 and the voltage supply 618 are used to bias the transistors 630 and 633 of the voltage-to-current converter 660. The mixer bias unit 684 shown in FIG. 7 includes the resistor 619 coupled to the center tap node 604 and the voltage supply 618.

The capacitor 624 is coupled in parallel to the inductor 603b, and the capacitor 627 is coupled in parallel to the capacitor 624 and these tuning capacitors are used to match the impedance between the single-ended low noise amplifier 43 and the differential mixer 49 in order to maximize the transfer of power from the differential signal produced at the inductor 603b to the inputs of the voltage-to-current converter 660. The impedance matching unit 678 shown in FIG. 7 includes the capacitor 624 that is coupled in parallel to the inductor 603b and the capacitor 627 that is coupled in parallel to the capacitor 624.

The differential mixer 49 includes the voltage-to-current converter 660 and the frequency downconverter 663. Because the inductor 603b produces a differential signal, a pair of transistors (the transistors 630 and 633) that each have their source coupled to ground are used as the voltage-to-current converter 660 of the differential mixer 49. The differential signal produced across the inductor 603b directly drives the gate of each of the transistors 630 and 633. The transistors 630 and 633 convert the differential signal input at their gates from a voltage form to a current form. The transistors 630 and 633 are biased through the center tap node 604 which has the resistor 619 coupled to the voltage supply 618. The voltage-to-current converter 660 does not use a current source. Therefore, the voltage-to-current converter 660 achieves low-voltage, low power, and balanced operation. In addition, the grounded-source transistors provide good linearity. For the transistor 630, its gate is coupled to the capacitor 627, its source is coupled to ground, and its drain produces a first half of the differential signal in current form (i.e., the first half of the differential signal output from the voltage-to-current converter 660). The voltage-to-current converter 660 includes the transistor 633 whose gate is coupled to the capacitor 627, whose source is coupled to ground, and whose drain produces a second half of the differential signal in current form. The voltage-to-current converter 660 also provides additional gain to the differential signal input at the gates of the transistors 630 and 633.

The frequency downconverter 663 includes a transistor 648 whose gate is coupled to a first half of a differential signal produced by the local oscillator 52, whose source is coupled to the first half of the differential signal produced by the voltage-to-current converter 660 (i.e., the first half of the differential signal in current form), and whose drain produces a first half of the intermediate frequency differential signal. Also included is a transistor 651 whose gate is coupled to a second half of the differential signal produced by the local oscillator 52, whose source is coupled to the first half of the differential signal produced by the voltage-to-current converter 660, and whose drain produces a second half of the intermediate frequency differential signal. A transistor 654 has a gate that is coupled to the second half of the differential signal produced by the local oscillator 52, a source that is coupled to the second half of the differential signal produced by the voltage-to-current converter 660, and whose drain produces the first half of the intermediate frequency differential signal. The frequency downconverter 663 also includes a transistor 657 whose gate receives the first half of the differential signal produced by the local oscillator 52, whose source is coupled to the second half of the differential signal produced by the voltage-to-current converter 660, and whose drain produces the second half of the intermediate frequency differential signal.

The frequency downconverter 663 mixes the differential signal provided by the voltage-to-current converter 660 with the differential signal output from the local oscillator 52 in order to generate the intermediate frequency differential signal that is at a lower frequency than the frequency of the differential signal provided by the voltage-to-current converter 660. One way of mixing in order to generate the intermediate frequency differential signal is to subtract the frequency of the differential signal from the frequency of the signal produced by the local oscillator. This difference provides the intermediate frequency differential signal that is used by other parts of the receiver.

Because the balun circuit 601 provides a symmetric differential signal to the transistor 630 and the transistor 633, differential operation occurs without using a conventional differential pair and a corresponding current source (the conventional differential pair has, for example, two transistors whose sources are tied together and biased with the current source). This provides, among others, the following benefits. First, low voltage (and low power) operation is enabled in the differential mixer 49 as it uses a stack of only two transistors (i.e., transistor 630 and transistor 633). Second, due to the grounded transistors 630 and 633 and the absence of the current source, this type of differential circuit improves linearity versus the conventional differential pair circuit when used in low cost CMOS technology.

An additional benefit of this circuit is that the inductors 603a and 603b together act as a dc block between the single-ended LNA 43 and the differential mixer 49. The inductors 603a and 603b filter out low frequency intermodulation (“IM”) products that may have been generated within the single-ended LNA 43. These IM products are a measure of the RF receiver front end's linearity. Specifically, the RF receiver front end 600 improves the IP2 of the RF receiver. The IP2 is a measure of how susceptible the RF receiver is to IM products.

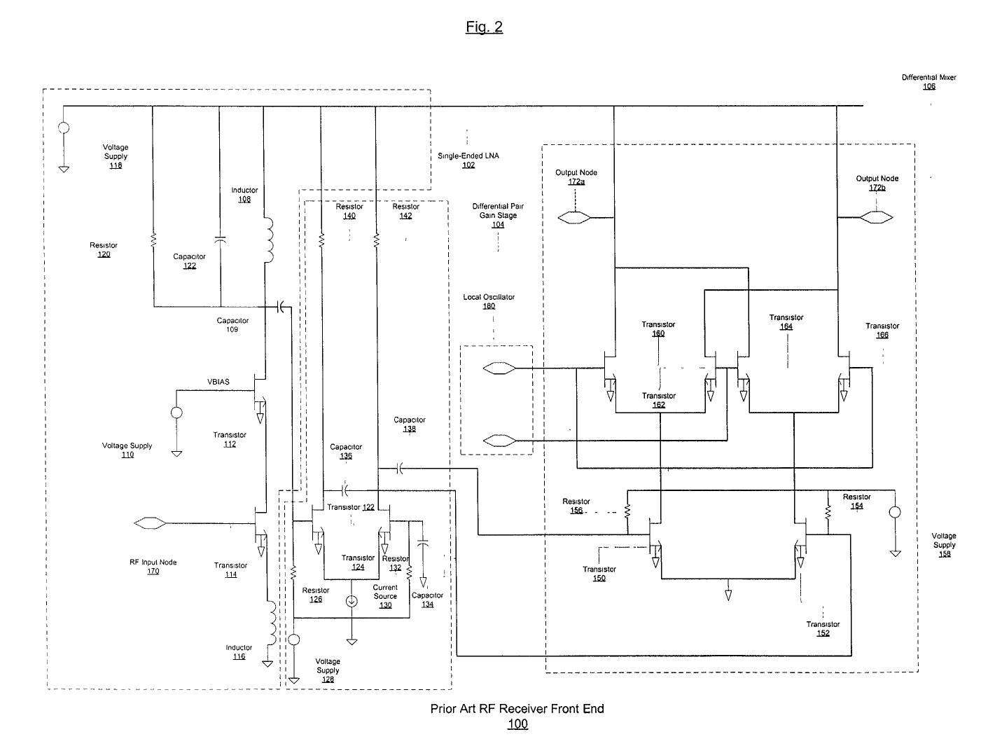

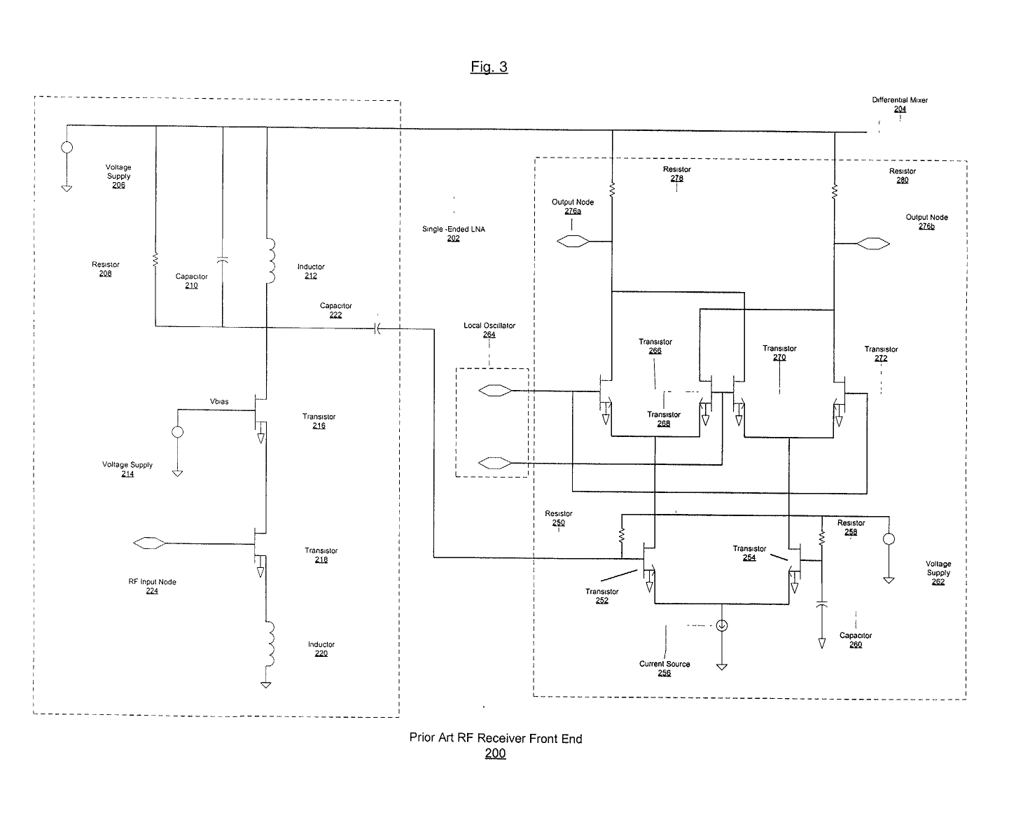

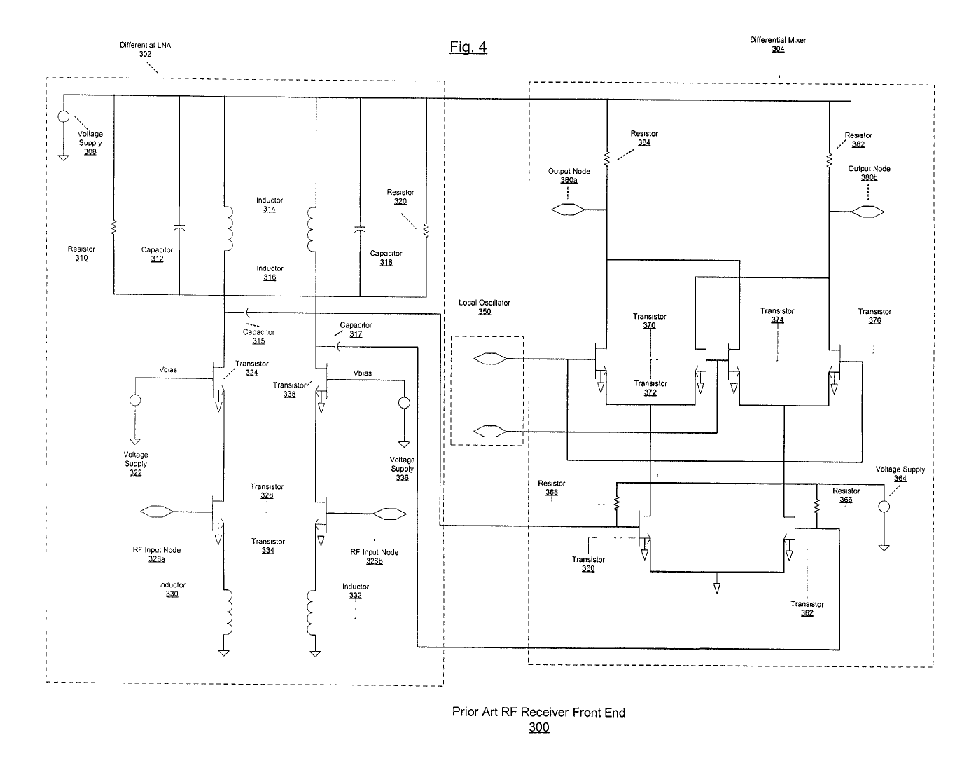

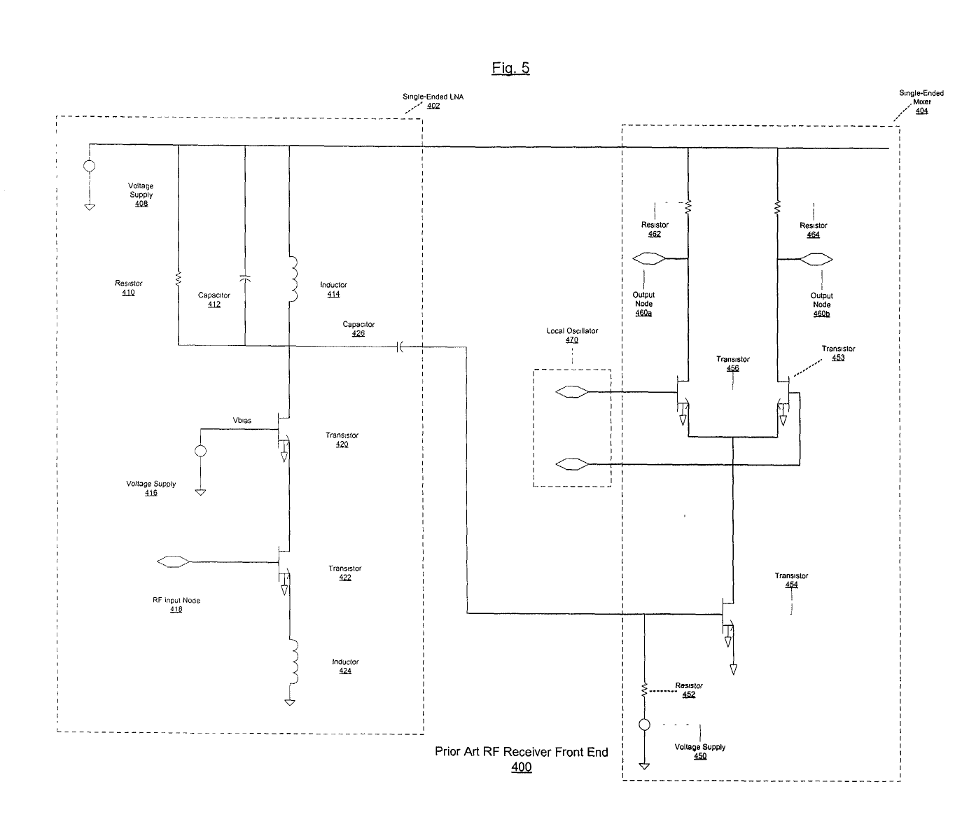

The embodiment described in FIG. 7 and FIG. 9 allow a fully integrated RF receiver front end that has all the benefits of both the single-ended LNA and the differential mixer without requiring extra external components and extra active circuitry that consumes power and degrades noise and linearity performance. The technique of passively coupling a single-ended signal to a differential mixer with no current source optimizes linearity performance and power consumption simultaneously. None of the existing design approaches discussed in FIGS. 2-5 allow the design of a fully integrated RF receiver front end with such high performance.

This embodiment is very effective at higher operating frequencies (e.g., the RF input is 900 MHz or higher) because it takes advantage of the fact that active transistors' gain degrades at higher operating frequencies while the quality factor of an on-chip balun (i.e., an integrated balun) can actually improve with higher operating frequencies. Thus, many commercial wireless applications in high frequency bands can utilize this design of the RF receiver front end. Also, this embodiment allows operation at low supply voltages, for example, the voltage supply 618 can be IV. Current radio transceivers typically work at 2.7V-3.6V. In the future, as supply voltages migrate downwards to reduce power consumption, this embodiment with its low power consumption characteristic will be especially desirable.

While the present invention has been particularly described with respect to the illustrated embodiments, it will be appreciated that various alterations, modifications and adaptations may be gated on the present disclosure, and are intended to be within the scope of the present invention. While the invention has been described in connection with what are presently considered to be the most practical and preferred embodiments, it is to be understood that the present invention is not limited to the disclosed embodiment but, on the contrary, is intended to cover various modifications and equivalent arrangements included within the scope of the claims.

What is claimed is:

1. An integrated radio frequency (“RF”) receiver front end, comprising:
a balun circuit, comprising:
a first inductor;
a second inductor, magnetically coupled to the first inductor, to transform a single-ended signal to a differential signal, wherein the second inductor has a center tap node;
a first capacitor, coupled in parallel to the first inductor, to form a resonance with the first inductor to maximize a gain of the single-ended signal;
a first resistor, coupled in parallel to the first capacitor, to stabilize the gain of the single-ended signal;
a second capacitor, coupled at one end to the center tap node and to AC ground at the other end, to improve the balance between a first half of the differential signal and a second half of the differential signal;
a third capacitor, coupled in parallel to the second inductor;
a fourth capacitor, coupled in parallel to the third capacitor, that together with the third capacitor matches the impedance between a low noise amplifier and a mixer; and
the mixer, coupled to the balun circuit, comprising:
a first transistor having a source, a gate, and a drain, the gate coupled to the fourth capacitor, the source coupled to ground, and the drain producing a first half of a differential signal in current form; and
a second transistor, together with the first transistor, to convert the differential signal from a voltage form to a current form, the second transistor having a source, a gate, and a drain, the gate coupled to the fourth capacitor, the source coupled to ground, and the drain producing a second half of the differential signal in current form.

2. The integrated RF receiver front end of claim 1 further comprising a low noise amplifier, coupled to the balun circuit, to amplify the single-ended signal.

3. The integrated RF receiver front end of claim 2 further comprising an antenna, coupled to the low noise amplifier, to receive an electromagnetic signal and convert it to the single-ended signal.

4. The integrated RF receiver front end of claim 1 wherein the balun circuit includes a mixer bias unit, coupled to the center tap node, to bias the mixer.

5. The integrated RF receiver front end of claim 4 wherein the mixer bias unit includes a second resistor, coupled to the center tap node, and a first voltage supply, coupled to the second resistor.

6. The integrated RF receiver front end of claim 2 wherein the balun circuit includes a low noise amplifier bias unit, coupled to the first inductor, to bias the low noise amplifier.

7. The integrated RF receiver front end of claim 1 wherein the low noise amplifier bias unit includes a second voltage supply, coupled directly to the first inductor.

8. The integrated RF receiver front end of claim 1 wherein the mixer includes
a third transistor having a source, a gate, and a drain, the gate coupled to a first half of a differential signal produced by a local oscillator, the source coupled to the first half of the differential signal in current form, and the drain producing at least some of a first half of an intermediate frequency differential signal;
a fourth transistor having a source, a gate, and a drain, the gate coupled to a second half of the differential signal produced by the local oscillator, the source coupled to the first half of the differential signal in current form, and the drain producing at least some of a second half of the intermediate frequency differential signal;
a fifth transistor having a source, a gate, and a drain, the gate coupled to a second half of the differential signal produced by the local oscillator, the source coupled to the second half of the differential signal in current form, and the drain producing at least some of the first half of the intermediate frequency differential signal; and
a sixth transistor having a source, a gate, and a drain, the gate coupled to the first half of the differential signal produced by the local oscillator, the source coupled to the second half of the differential signal in current form, and the drain producing at least some of the second half of the intermediate frequency differential signal.

9. An integrated balun circuit that receives a single-ended signal, comprising:
a balun to passively convert a single-ended signal to a differential signal;
a resonance forming unit, coupled to the balun, to maximize a gain of the single-ended signal;
a gain stabilizing unit, coupled to the balun, to stabilize the gain of the single-ended signal;
a balun grounding unit, coupled to the balun, to improve the balance between a first half of the differential signal and a second half of the differential signal; and
an impedance matching unit, coupled to the balun, to match the impedance between a low noise amplifier and a mixer to maximize transfer of the passively converted differential signal.

10. The integrated balun circuit of claim 9 further comprising a LNA bias unit, coupled to the balun, to bias a low noise amplifier.

11. The integrated balun circuit of claim 9 further comprising a mixer bias unit, coupled to the balun, to bias the mixer.

12. The integrated balun circuit of claim 9 wherein the balun includes a first inductor and a second inductor where the first inductor is magnetically coupled to the second inductor and the second inductor has a center tap node.

13. The integrated balun circuit of claim 12 wherein the resonance forming unit includes a first capacitor, coupled in parallel to the first inductor.

14. The integrated balun circuit of claim 13 wherein the gain stabilizing unit includes a first resistor, coupled in parallel to the first capacitor.

15. The integrated balun circuit of claim 12 wherein the balun grounding unit includes a second capacitor, coupled to the center tap node at one end and to AC ground at the other end.

16. The integrated balun circuit of claim 12 wherein the impedance matching unit includes a third capacitor, coupled in parallel to the second inductor, and a fourth capacitor, coupled in parallel to the third capacitor.

17. An integrated radio frequency (“RF”) receiver front end, comprising:
a balun to passively convert a single-ended signal to a differential signal;
a resonance forming unit, coupled to the balun, to maximize a gain of the single-ended signal;
a gain stabilizing unit, coupled to the balun, to stabilize the gain of the single-ended signal;
a balun grounding unit, coupled to the balun, to improve the balance between a first half of the differential signal and a second half of the differential signal;
an impedance matching unit, coupled to the balun, to match the impedance between a low noise amplifier and a mixer to maximize transfer of the passively converted differential signal; and
a voltage-to-current converter to convert the differential signal from a voltage form to a current form without using a current source.

18. The integrated RF receiver front end of claim 17 further comprising a LNA bias unit, coupled to the balun, to bias the low noise amplifier.

19. The integrated RF receiver front end of claim 17 further comprising a mixer bias unit, coupled to the balun, to bias the mixer.

20. The integrated RF receiver front end of claim 17 wherein the balun includes a first inductor and a second inductor where the first inductor is magnetically coupled to the second inductor and the second inductor has a center tap node.

21. The integrated RF receiver front end of claim 20 wherein the resonance forming unit includes a first capacitor, coupled in parallel to the first inductor.

22. The integrated RF receiver front end of claim 21 wherein the gain stabilizing unit includes a first resistor, coupled in parallel to the first capacitor.

23. The integrated RF receiver front end of claim 20 wherein the balun grounding unit includes a second capacitor, coupled to the center tap node at one end and to AC ground at the other end.

24. The integrated RF receiver front end of claim 20 wherein the impedance matching unit includes a third capacitor, coupled in parallel to the second inductor, and a fourth capacitor, coupled in parallel to the third capacitor.

25. The integrated RF receiver front end of claim 24 wherein the voltage-to-current converter includes
a first transistor having a source, a gate, and a drain, the gate coupled to the fourth capacitor, the source coupled to ground, and the drain producing a first half of the differential signal in the current form; and
a second transistor having a source, a gate, and a drain, the gate coupled to the fourth capacitor, the source coupled to ground, and the drain producing a second half of the differential signal in the current form.

26. The integrated RF receiver front end of claim 17 further comprising a frequency downconverter, coupled to the voltage-to-current converter, to mix the differential signal in the current form with a differential signal produced by a local oscillator to produce an intermediate frequency differential signal that is at a lower frequency than the differential signal in the current form.

27. The integrated RF receiver front end of claim 26 where in the frequency downconverter includes
a third transistor having a source, a gate, and a drain, the gate coup led to a first half of a differential signal produced by the local oscillator, the source coupled to the first half of the differential signal in the current form, and the drain producing at least some of a first half of the intermediate frequency differential signal;
a fourth transistor having a source, a gate, and a drain, the gate coupled to a second half of the differential signal produced by the local oscillator, the source coupled to the first half of the differential signal in the current form, and the drain producing at least some of a second half of the intermediate frequency differential signal;
a fifth transistor having a source, a gate, and a drain, the gate coupled to the second half of the differential signal produced by the local oscillator, the source coupled to the second half of the differential signal in current form, and the drain producing at least some of the first half of the intermediate frequency differential signal; and
a sixth transistor having a source, a gate, and a drain, the gate coupled to the first half of the differential signal produced by the local oscillator, the source coupled to the second half of the differential signal in current form, and the drain producing at least some of the second half of the intermediate frequency differential signal.

28. A method for converting a single-ended signal to a differential signal, comprising:
resonating at an operating frequency to maximize a gain of the single-ended signal;
stabilizing the gain of the single-ended signal;
passively converting the single-ended signal to produce a differential signal;
grounding a balun to improve the balance between a first half of the differential signal and a second half of the differential signal;
matching the impedance between a low noise amplifier and a mixer to maximize the power transfer of the differential signal; and
converting the differential signal from a voltage form to a current form without using a current source.

29. The method of claim 28 further comprising providing a bias to the low noise amplifier and the mixer.

30. The method of claim 28 further comprising matching a load of the low noise amplifier with a load of the mixer.

31. The method of claim 28 further comprising providing the gain to the single-ended signal.

32. The method of claim 28 further comprising providing a load to the low noise amplifier.

33. The method of claim 28 wherein passively converting the differential signal to current form includes providing gain to the differential signal.

34. The method of claim 33 further comprising mixing the differential signal in the current form with a signal from a local oscillator to produce an intermediate frequency differential signal that is at a lower frequency than the differential signal in the current form.

35. The method of claim 28 wherein passively converting the single-ended signal to produce the differential signal includes filtering out low frequency intermodulation products from the single-ended signal.
